(19) United States
(12) Patent Application Publication
(10) Pub. No.: US 2009/0144272 A1
(43) Pub. Date: Jun. 4, 2009

(54) RATING RATERS

(75) Inventors: Anurag Adarsh, Bangalore (IN); Apurv Gupta, Bangalore (IN); Vihari Komaragiri, Bangalore (IN)

Correspondence Address: FISH & RICHARDSON P.C., PO BOX 1022, MINNEAPOLIS, MN, 55440-1022, US

(73) Assignee: GOOGLE INC., Mountain View, CA (US)

(21) Appl. No.: 12/326,722

(22) Filed: Dec. 2, 2008

Related U.S. Application Data
(60) Provisional application No. 61/005,482, filed on Dec. 4, 2007.

(51) Int. Cl. G06F 7/06; G06F 17/30

(52) U.S. Cl. 707/5; 707/E17.014; 707/E17.108

(57) ABSTRACT

A computer-implemented method includes identifying a plurality of ratings on a plurality of items, wherein the plurality of ratings are made by a first user, determining one or more differences between the plurality of ratings, and ratings by other users associated with the items, and generating a quality score for the first user using the one or more differences.

### CROSS REFERENCE TO RELATED APPLICATION

This application claims priority to pending U.S. Provisional Application Ser. No. 61/005,482 entitled Rating Raters, filed on Dec. 4, 2007, the entire contents of which are incorporated herein by reference.

### TECHNICAL FIELD

This document discusses systems and methods for determining the quality of ratings provided to items such as consumer products, books, and web pages, by users of a networked system such as the internet.

### BACKGROUND

The internet is filled with information—too much for any one person to comprehend, let alone review and understand. Search engines provide one mechanism for people to sort the wheat from the chaff on the internet, and to isolate information that is most relevant to them. People may also use various ratings systems to identify items using the internet In these ratings systems, other people indicate whether an item is good or bad by rating the item, such as by explicitly giving the item a numerical rating (e.g., a score on a scale of 10). For example, a user may rate a product on a retailer's web site, and thus indicate whether they think others should purchase the product. Users may also implicitly rate an item, such as by viewing an on-line video without skipping to another video. In addition to rating products and services, users may also rate internet-accessible documents, such as articles in web pages, or on-line comments made by other users.

Some people are motivated to “game” ratings systems. For example, a user who makes a particular product may seek to submit numerous falsely positive ratings for the product so as to drive up its composite rating, and to thus lead others to believe that the product is better than it actually is. Likewise, a user may attempt to decrease the score for a competitor's product.

### SUMMARY

This document discusses systems and techniques for recognizing anomalous rating activity. In general, ratings provided by various raters are judged against ratings provided by other raters, and the difference of a particular rater from the majority is computed. If the difference is sufficiently high, the particular rater may be determined to be a bad rater or a dishonest rater. Such information may be used in a variety of manners, such as root out dishonest, spamming raters and eliminate their ratings from a system or restrict their access or rights in a system. Also, rated items can have their ratings or scores affected by such a system and process. For example, a composite rating for an item may be made up of various ratings from different users, where the rating from each user is weighted according to a measure of the quality of their overall ratings.

In one implementation, a computer-implemented method is disclosed. The method includes performing in one or more computers actions including identifying a plurality of ratings on a plurality of items. The plurality of ratings are made by a first user. One or more differences are determined between the plurality of ratings, and ratings by other users associated with the items, and a quality score is generated for the first user using the one or more differences. The plurality of ratings can be explicit ratings within a bounded range, and the method can further comprise identifying the first user by receiving from the first user an ID and password. Also, the items can comprise web-accessible documents. In addition, the method may include ranking one or more of the web-accessible documents using the quality score. The method can also include receiving a search request and ranking search results responsive to the search request using quality scores for a plurality of users rating one or more of the search results.

In certain aspects, the method comprises generating scores for authors of one or more of the web-accessible documents using the quality score. Also, the item of the method can comprise a user comment, and the quality score can be based on an average difference between the first user's rating and other ratings for each of a plurality of items. The quality score can be compressed by a logarithmic function also. Moreover, the method may comprise generating modified ratings for the plurality of items using the quality score, and can also comprise generating a quality score for a second user based on the quality score of the first user and comments relating to the second user by the first user.

In another implementation, a computer-implemented system is disclosed. The system comprises memory storing ratings by a plurality of network-connected users of a plurality of items, a processor operating a user rating module to generate ratings for users based on concurrence between ratings of items in the plurality of items by a user and ratings by other users, and a search engine programmed to rank search results using the generated ratings for users. The plurality of ratings can be contained within a common bounded range, and the user rating module can be programmed to generate a rating for a first user by comparing a rating or ratings of an item by the first user to an average rating by users other than the first user. Also, the search results can comprise a list of user-rated documents, and the ratings of items can be explicit ratings. In addition, the rating module can further generate rating information for authors of the items using the generated ratings for users.

In yet another implementation, a computer-implemented system is disclosed that includes memory storing ratings by a plurality of network-connected users of a plurality of items, means for generating rater quality scores for registered users who have rated one or more of the plurality of items, and a search engine programmed to rank search results using the rater quality scores. The items can comprise web-accessible documents having discrete, bound rankings from the network-connected users.

The details of one or more embodiments are set forth in the accompanying drawings and the description below. Other features, objects, and advantages will be apparent from the description and drawings, and from the claims.

### DESCRIPTION OF DRAWINGS

FIG. 1 shows a conceptual diagram of ratings and subsequent rankings of items where certain raters are “good” and certain are “bad”.

FIG. 2 shows a conceptual diagram for computing quality scores for raters of web documents.

FIG. 3 is a flow diagram showing a process flow for computing and using rater quality scores.

FIG. 4 is a flow chart showing a process for computing rater quality scores.

FIG. 5 is a flow chart showing a process for computing rater quality scores for items in multiple categories.

FIG. 6 is a swim lane diagram showing actions relating to rating of items on a network.

FIG. 7 is a schematic diagram of a system for managing on-line ratings.

FIG. 8 is a screen shot of an example application for tracking user ratings.

FIG. 9 shows an example of a generic computer device and a generic mobile computer device.

Like reference symbols in the various drawings indicate like elements.

### DETAILED DESCRIPTION

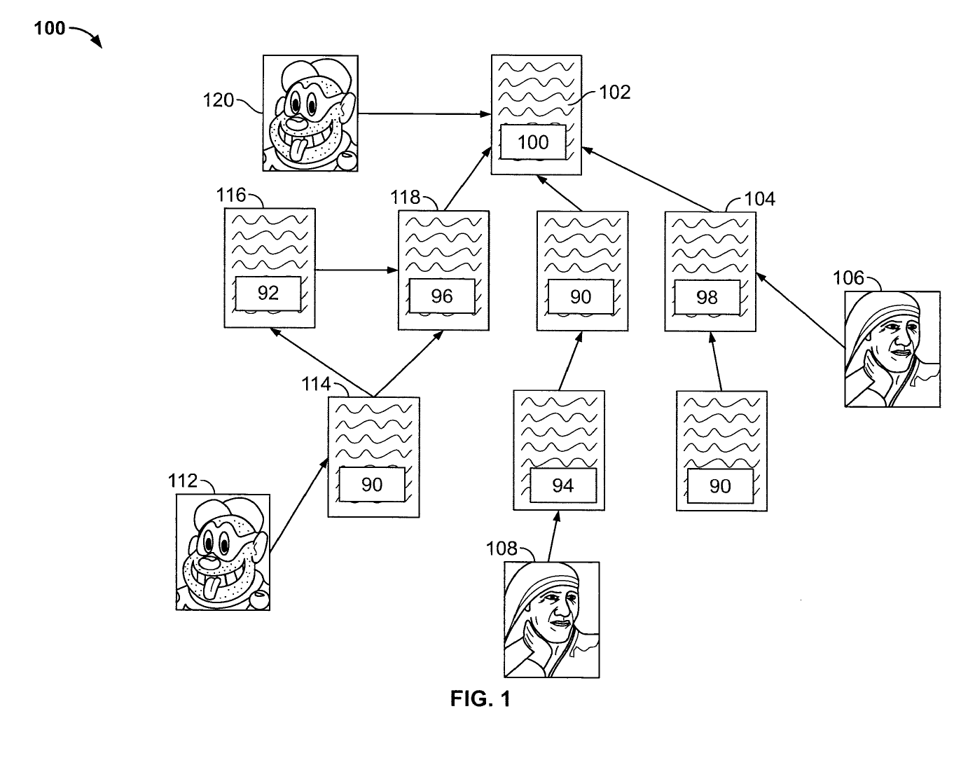

FIG. 1 shows a conceptual diagram of ratings and subsequent rankings of items where certain raters are “good” and certain are “bad.” In general, the figure shows a situation in which various items, such as documents, may be given scores, where those scores are used, for example, to link the items for display to a user, or simply to show the particular scores to a user. In this particular example, items in the form of web-based documents may refer to each other, such as by including a hyperlink from one document to another, and items may also be referenced, such as through an applied rating, by various users. A combination of item-to-item (document-to-document) references, and user-to-item (user-to-document) references may thus be used to generate a score for an item (document).

As shown in the figure, certain users are good and certain users are bad. In this example, the bad users 112, 120, are represented by an image of a Beagle boy from the Scrooge McDuck comic series. For this example, the bad users 112, 120, are users who rate items dishonestly for the purpose of having the items achieve unfair attention. For example, a friend of the bad users 112, 120, may be associated with particular items, and the bad users 112, 120 may provide artificially high ratings or reviews for such items. In certain contexts, the bad users may also be referred to as fraudsters.

In the example, good users 106, 108 are represented by images of Mother Teresa. The good users 106, 108 are presumed to be users who are motivated by proper goals, and are thus providing honest ratings or other reviews of items. As a result, it may be generally assumed that ratings provided by the good users 106, 108 generally match ratings provided by the majority of users, and that ratings provided by the bad users 112, 120 generally do not match ratings provided by the majority of users.

Item 102 is shown as having a score of 100, on a scale that tops out at 100. Other scales for scoring may also be used, of course, and the particular scale selected here is used for purposes of clarity in explanation only. The score for item 102 is generated as a combination of a rating from bad user 120 and the links from three different items, including item 104 and item 118. The scores for the linking items may in turn be dependent on the links from other items and votes from other users. For example, item 104 receives a link from one other item and a positive ranking from good user 106. The passing of scores from one document to another document through forward linking relationships, and the increasing of a score for a document if it is pointed to by other documents having high scores, is generally exemplified by the well-known GOOGLE PAGERANK system.

The example here shows that item 102 may have an improperly inflated ranking. In particular, bad user 120 has voted up item 102 improperly, and bad user 112 has voted up item 114 improperly. The improper inflation of the score for item 114 further increases the score for item 102 by passing through items 116 and 118 (which themselves have improperly inflated scores).

At the same time, although item 104 points to item 102, and has a score that is lower than that of item 102, it may rightfully be the most relevant item when the improper influence of bad users 112, 120 is removed from the system. Plus, an honest reading of the system (i.e., with the ratings or votes by the bad users 112,120 eliminated) may result in item 100 no longer being indicated as the highest scoring item in the system.

The discussion below discloses various mechanisms by which the improper influence of users such as bad users 112, 120, may be rooted out of a system, so that more honest scores or rankings may be provided for various items. Although the example here shows the items as being documents such as web pages, the items may take a variety of other forms, such as comments provided by users to other documents, physical items such as consumer goods (e.g., digital cameras, stereo systems, home theater systems, and other products that users might rate, and that other users may purchase after reviewing ratings), and various other items for which users may be interested in relative merits compared to other similar items, or which may be used by a computer system to identify or display relevant information to a user.

Although this particular example involved ratings or rankings in two different dimensions, i.e., with explicit ratings by users, and implicit ratings by hyperlinks from items to items, other such scenarios may also be treated with a ratings management system. For example, simple ratings of items may be used such as explicit ratings of one to five stars for physical items, provided to items by users through an online interface. In such a situation, the bare ratings in a single dimension (user to item) may be analyzed and managed to help reduce the influence of fraudsters or spammers.

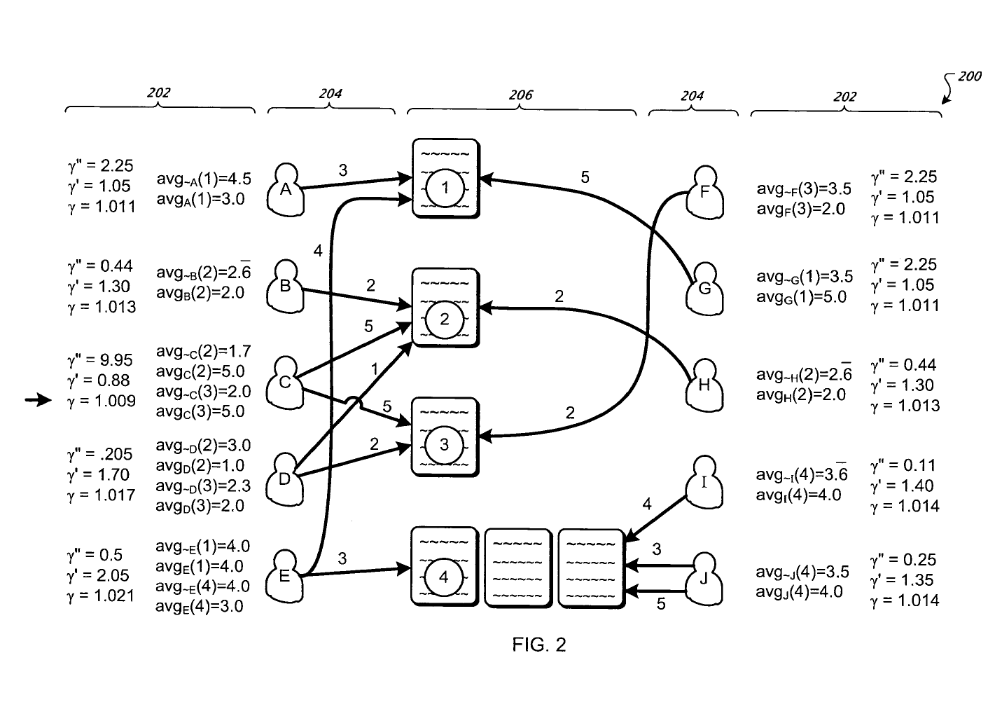

FIG. 2 shows a conceptual diagram for computing quality scores for raters of web documents. In general, a score or multiple scores may be generated for each user in a system who has rated an item, where the score reflects the concurrence or correlation between the user's scoring of items and the scoring of the same or similar items by users other than the particular user. Presence of concurrence may produce a relatively high score that represents that the user provides ratings in tune with the public at large, and is thus likely to be an honest user whose ratings may be used or emphasized in the system. In contrast, lack of concurrence may indicate that the user is likely a fraudster whose ratings are motivated by improper purposes. Because such a score is based on expectation or inference that it will represent a relative quality of a user who rates items (a “rater”), the score may be called a quality score, or more broadly, a quality indicator or indication.

Also, to address users who are optimists and thus consistently give high ratings and users who are pessimist and give low rating, individual ratings may first be normalized by user, so that particular global bias for a user may be eliminated, and aberrant behavior may be identified.

The figure shows various values in an example process 200 of computing quality scores for various users, shown as users A to J (in columns 204). Those users have each provided a rating, in a bounded range of integers from 1 to 5, to one or more of documents 1 to 4, which may be internet web pages or comments made by other users. The documents, in column 206, are shown as including one to three pages, as an example, but may be represented in many other manners. A rating by a user of a document is shown in the figure by an arrow directed at the document, and the value of the rating is shown by an integer from 1 to 5.

In formulating the quality scores for the various users, a value of Nᵣ(X,Y) may be established as the number of times a user X has rated an item Y (where the item may be a product, a document or web page, another user, a comment by another user or other such item). The rating values actually provided by a user to an item, without correction to root out anomalous behavior, may be referenced as raw ratings. The value of rᵢ(X, Y) denotes the ith raw-rating given by X to Y A sum of all of X's ratings for item Y may then be computed as:

$${S}_{r} ( X , Y ) - {\sum }_{i = 0}^{{N}_{r} ( X , Y )} {r}_{i} ( X , Y )$$

The average rating provided to item Y by all users other than user X, denoted as avg˜x(Y), and the average rating provided to item Y by user X, denoted as avgx(Y), may be calculated as follows:

$${avg}_{\sim X} ( Y ) = \frac{{\sum }_{{X}^{′} \neq X} {S}_{r} ( {X}^{′} , Y )}{{\sum }_{{X}^{′} \neq X} {N}_{r} ( {X}^{′} , Y )}$$

$${avg}_{X} ( Y ) = \frac{{S}_{r} ( X , Y )}{{N}_{r} ( X , Y )}$$

Columns 202 in FIG. 2 show such average ratings for the various users. Thus, as one example form the figure, user D's average rating of item 3 is 2.0, while the average rating of item 3 by the other users (where users D and F are the other users who have rated item 3) is 2.3. As another example, the average rating by user H of item 2 is 2.0 (a single rating of 2), while the average ratings form the other users of item 2 is 2.7 (ratings of 2, 5, and 1). As can be seen, the ratings provided by user C have been selected to be arbitrarily high to see if the process described here will call out user C as an anomalous, and thus potentially dishonest (or perhaps just incompetent) rater.

A quality precursor, referenced as γ″, may then be computed to show variation between the user's ratings and those of others that takes into account the difference from the average (i.e., all ratings by the particular user), as follows:

$${y}^{″} ( X ) = \frac{\sum {( {avg}_{∼ X} ( Y ) - {avg}_{X} ( Y ) )}^{2} )}{\vert Y \vert}$$

This factor is a correlation measure between ratings from user X and those of others. Unlike standard correlation coefficients, which generally lie between −1 and +1, however, this factor may lie between MIN_RATING_VALUE and MAX_RATING_VALUE. Under this example, if the variable-average scores are substituted with per item average ratings, the precursor is effective a standard deviation for the rater.

A quality score γ′ can then be represented by

γ′(X)=(R_{mdiff}−\sqrt{γ″(X)})log(|Y|+1)

where R_{mdiff} is the difference of minimum and maximum scores possible in a bound rating system (here, 1 and 5), and where |Y| is the cardinality of the set of Y, or in other words, the number of items that were rated both by user X and by at least one other user. This transformation of γ″(X) to γ′(X) acts to reverse the orientation of the score. In particular, γ″(X) is higher for fraudulent users, while γ′(X) is lower, and γ′(X) also better takes into account user who are in consensus with a high number of other users, from users who are in consensus only with a small number of other users. Also, a squashing function is used here as the multiplying factor so that people do not benefit simply because of rating many other users.

Applying these formulae to the example system in FIG. 2, the gamma values or quality scores of user B, who is intended to represent a fraudster based on his or her assigned ratings, and of user E, who is intended to be a good, accurate, honest, or other such rater, may be computed as follows:

γ″(B)=(2.7−2.0)²/1=0.7²=0.49

γ′(B)=(5−sqrt(0.49))log(1+1)=4.3*0.301=1.3

and

γ″(E)=((4.0−4.0)²+(4.0−3.0)²)/2=0.5

γ′(E)=(5−sqrt(0.5))log(2+1)=4.29*0.477=2.05

γ′ is, in this example, an indicator of a person's experience and expertise in giving ratings. The various γ′ values for each user in the example is shown in FIG. 2. As was expected, the γ′ score for user C, who was purposefully established in the example to be a fraudster, is the lowest score. The score does not differ greatly from the scores of the other user, however, because application of the log function decreases the score, and also, all of the users in the example had made only one or two ratings, so there was little opportunity for one user to increase their score significantly on the basis of experience.

In theory, the values for γ′ could be arbitrarily large. However, very many ratings of an object, such as on the order of 10⁶, would be needed to drive the number very large. As a result, the value of γ′ for a user can be used to be between 0 and 20*R_{mdiff}. The value of gamma can therefore be normalized to a value between 1 and 2 by the following formula:

γ(X)=(γ′(X)/(20*R_{mdiff}))+1

Such a figure can be applied more easily to a rating so as to provide a weighting for the rating. Other weighting ranges may also be employed, such as to produced weighted ratings between 0 and 1; −1 and +1; 1 and 10; or other appropriate ranges.

Such a weighted rating may be referenced as a “global rating”, which may depend on the raw rating according to the following exemplary formula for a global rating for item Y, as follows:

$${G}_{r} ( Y ) = {\sum }_{X} γ ( X ) log ( {S}_{r} ( X , Y ) + 1 )$$

where X is a person who has rated Y. By taking the log of the sum of the rating, such an approach can prevent multiple ratings from a single user from affecting a global score significantly.

Typically, an item is rated by only a few people and many items may have no ratings at all. As a result, computing any statistically significant measure may be difficult for such items. Such difficulty may be avoided in part by assigning ratings to a producer of the item rather than to the item itself. Presumably, a producer of an item will have produced many such items (such as articles on various topics), those items will have had generally consistent quality, and there will have been many more ratings associated with all of the producer's items than with one particular item alone.

Also, as discussed, squashing functions (i.e., functions with a positive first derivative but a negative second derivative) may be used to reward people who have a large number of interactions, i.e., ratings in the system. Such an approach may help filter out short-term fraudsters who enter the system to bid up a particular item, but leave their fingerprints by not showing a more long-term interest in the system. Also, other systems may be used to affect scores so as to reflect that a user has interacted with the system rather consistently over a long period, rather than by a flurry of time-compressed activity, where the latter would indicate that the user is a fraudster (or even a bot).

Additional features may also be provided along with the approach just discussed or with other approaches. For example, gaming of the system by a fraudster may also be reduced by the manner in which certain ratings are selected to be included in the computations discussed here. Specifically, a fraudster may attempt to cover his or her activities by matching their ratings to those of other users for a number of items so as to establish a “base of legitimacy.” Such tactics can be at least partially defused by comparing a user's ratings only to other ratings that were provided after the user provided his or her rating. While such later ratings may be similar to earlier ratings that the fraudster has copied, at least for items that have very large (and thus more averaged) ratings pools, such an approach can help lower reliance on bad ratings, particularly when the fraudster provided early ratings. Time stamps on the various ratings submissions may be used to provide a simple filter that analyzes only post hoc ratings from other users.

In addition or alternatively, weights to be given a rating may correspond to the speed with which the user provided the rating or ratings. In particular, a user can be presumed to have acted relatively independently, and thus not have attempt to improperly copy ratings from others, if the user's rating was provided soon The speed of a rating may be computed based on the clock time between an item becoming available for rating and the time at which a particular user submitted a rating, computed either as an absolute value or as a value relative to the time taken by other users to provide ratings on the same item (e.g., as a composite average time for the group). Alternatively, the speed of the rating may be computed as a function of the number of ratings that came before the user provided his or her rating, and the number of ratings that occurred during a particular time period after the user provided his or her rating.

In another implementation, preprocessing of ratings may occur before the method discussed above. For example, raters who provide too many scores of a single value may be eliminated regardless of the concurrence or lack of concurrence between their ratings and those form other users. Such single-value ratings across a large number of items may indicate that a bot or other automatic mechanism made the ratings (particularly if the ratings are at the top or bottom of the allowed ratings range) and that the ratings are not legitimate.

Also, a rating process may be run without the ratings of users determined to be dishonest, so that other honest users are not unduly punished if their ratings were often in competition from dishonest raters. Thus, for example, the gamma computation process may be run once to generate gamma scores for each user. All users having a gamma score below a certain cut-off amount may be eliminated from the system or may at least have their ratings excluded from the scoring process. The process may then be repeated so that users who rated many items that were rated by “bad” users should receive relatively higher scores, because their scores will no longer be depressed by the lack of correlation between their ratings and those of bad users. Other mechanisms may also be used for calculating quality scores for users based on the correlation or lack of correlation between their ratings and ratings of other users.

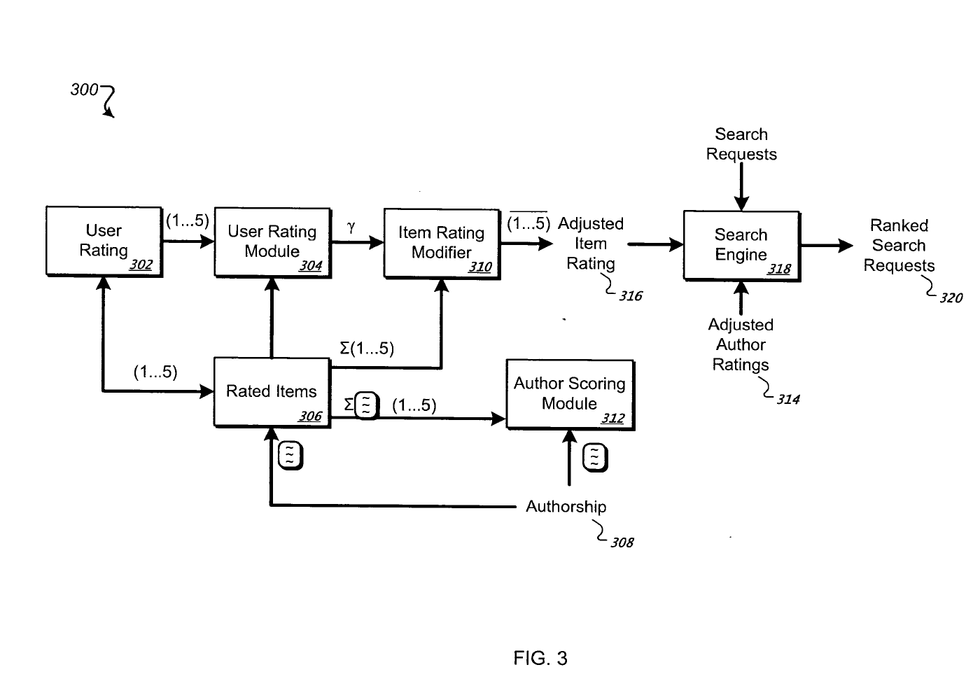

FIG. 3 is a flow diagram showing a process flow 300 for computing and using rater quality scores. In general, the process flow 300 is an ongoing flow of information by which ratings are being constantly received, and ratings of the raters are being constantly updated. Such a system may be implemented, for example, at a web site of a large retailer that is constantly receiving new rating information on products, or at a content hosting organization that permits users to comment on content provided by others or comments made by others.

At box 306, items are received into the system. The items may take a variety of forms, such as web pages, articles for purchases, comments of other users, and the like. The process 300 may index the items or otherwise organize them and present them so that they can be commented on and/or rated, and so that the comments or ratings can be conveniently tracked and tabulated.

At box 302, user ratings are received. Users may generally choose to rate whatever item they would like, such as an item article they are reading on-line, or a product they purchased from a particular retailer. Explicit ratings systems may permit rating of objects in a binary manner (e.g., thumbs-up or thumbs-down), as a selected number such as an integer, or a number of particular objects, such as a selection from zero to five stars or other such objects. Generally, the rating system will involve scoring within some bounded range. The rating may also be implicit, such as by a measure of time that a user spends watching a piece of content such as a web page, a video, or a commercial. In this example, the rating is allowed to be 1, 2, 3, 4, or 5.

A user rating module, at box 304, generates a quality measure for the various raters who have rated items. The rating may be in the form of a score showing a level of concurrence or lack of concurrence between a particular user's ratings and those of other users, such as by the techniques described above. The score, shown as gamma here, may then be passed to an item rating modifier 310 along with raw item rating scores from box 306. Adjusted item ratings 316 may thus be produced by item rating modifier, such as by raising ratings for items that scored high from “good” users and lower ratings for items that scored high from “bad” users. Such modification may include, as one example, applying each user's gamma figures to the user's ratings and then generating a new average rating for an object, perhaps preceded or supplemented by a normalizing step to keep the modified rating within the same bound range as the original raw ratings.

Such adjusted ratings may be provided to a search engine 318 in appropriate circumstances. For instance, for a product-direct search engine, ratings from users may be used in whole or in part to determine the display order, or ranking, of the search results. Other factors for determining a ranking may be price and other relevant factors. For example, if a person submits a search request 322 of “$300 digital camera,” the search engine 318 may rank various results 320 based on how close they are to the request $300 price points, and also according to their ratings (as modified to reflect honest rankings) from various users. Thus, for example, a $320 camera with a rating of 4.5 may be ranking first, while a $360 camera with a rating of 4.0 may be ranked lower (even if a certain number of “bad” people gave dozens and dozens of improper ratings of 5.0 for the slightly more expensive camera. Uniquely, for this example, a price point of $280 would be better, all other things being equal, than a price point of $300, so distance from the requested price is not the only or even proper measure of relevance.

The adjusted item rankings 316 may also be provided to an author scoring module 312. Such a module may be useful in a collaborative content setting, where users are permitted to rate content submitted by other users. For example, a certain blogger or other on-line author may post a number of short stories, and readers can rate the quality of the stories. Such ratings are subject to bad users trying to push a friends' stories up or an enemy's stories down improperly. Thus, the scores or ratings for particular articles or comments (i.e., which are particular types of items as discussed here) can be adjusted upward or downward by item rating modifier 310 to decrease or eliminate such harmful ratings.

The author scoring module 312 aggregates such ratings on items of authorship, correlates them with authorship information for the items obtained from authorship module 308. Authorship module 308 may be a system for determining or verifying authorship of on-line content so that readers may readily determine that they are reading a legitimate piece of writing. For example, such a system would help prevent a rookie writer from passing himself or herself off as Steven King or Brad Meltzer.

The author scoring module may use the adjusted item ratings to produce adjusted author ratings 314. Such ratings may simply be an average or weighted average of all ratings provided in response to a particular author's works. The average would be computed on group that does not include ratings from “bad” people, so that friends or enemies of authors could not vote their friends up or their enemies down.

As shown, the adjusted author ratings may also be provided as a signal to the search engine 318. Thus, for example, a user may enter a search request of “conservative commentary.” One input for generating ranked results may be the GOOGLE PAGERANK system, which looks to links between web pages to find a most popular page. In this example, perhaps a horror page for an on-line retailer like Amazon would be the most popular and thus be the top rated result. However, ranking by authors of content may permit a system to draw upon the feedback provided by various users about other users. Thus, for a page that has been associated with the topic of “conservative commentary,” the various ratings by users for the author of the page may be used. For example, one particularly well-rated article or entry on the page may receive a high ranking in a search result set. Or a new posting by the same author may receive a high ranking, if the posting matches the search terms, even if the posting itself has not received many ratings or even many back links—based on the prior reputation generated by the particular author through high ratings received on his or her prior works.

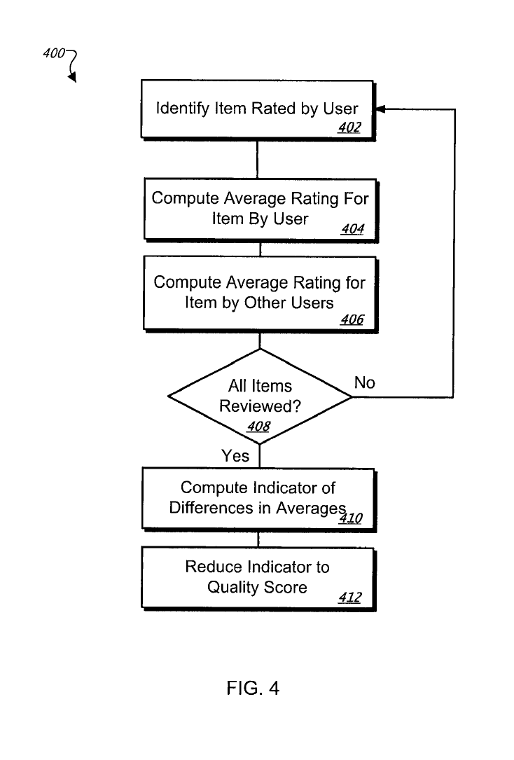

FIG. 4 is a flow chart showing a process 400 for computing rater quality scores. In general, the process 400 involves identifying rated items and computing a quality score for one or more raters of the rated items.

In box 402, an item rated by a user is identified. Such identification may occur, for example, by crawling of various publicly available web sites by known mechanisms. Where signatures of a rating are located, such as by a portion of a page matching the ratings layout of a commonly used content management system, the rating may be stored, along with identifying information for the rater and the author of the item if the item is a document such as a web page or a comment. Various mechanisms may be used for identifying raters, such as by requiring log in access to an area across which the ratings will occur.

At box 404, the average rating for the item for a particular user is computed. For example, if the user has provided two thumb's up ratings to a piece of music, the average score could be 1.0, while one thumb's up and one thumb's down could generate an average rating of 0.5. The process 400 then makes a similar computation for the average of ratings provided to the item by all users other than the particular user being analyzed (box 406). With the computations performed, the process 400 determines whether all rated items have been located and analyzed, and if not, the process 400 returns to identifying rated items (boxes 408, 402).

If all rated items have been located, then the process 400 computes an indicator of a difference in average between the person being analyzed and other users (box 4 1 0). Alternatively, the process 400 may identify another indicator of correlation or non-correlation between the analyzed user and the majority or whole of the other users. The process 400 then reduces the determined indicator of correlation or non-correlation to an indicator of a quality score. In particular, various transformations may be performed on the initial correlation figure so as to make the ultimate figure one that can be applied more easily to other situations. For example, the revised quality score may be one that is easily understood by lay users (e.g., 1 to 5, or 1 to 10) or easily used by a programmed system (e.g., 1 to 2, or 1 to 1).

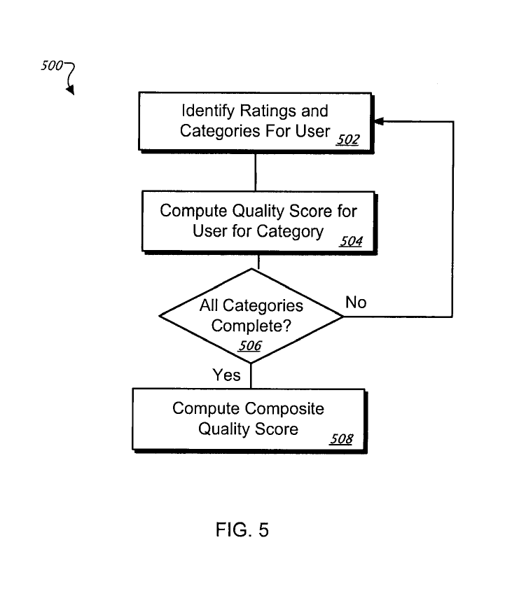

FIG. 5 is a flow chart showing a process 500 or computing rater quality scores for items in multiple categories. In general, this process 500 is similar to those discussed above, but it recognizes that certain users take on different personas in different settings. For example, a physics professor may give spot on ratings of physics journal submissions, but may have no clue about what makes for a good wine or cheese. Thus, the professor may be a very good rater in the academic realm, but a lousy rater in the leisure realm. As a result, the process 500 may compute a different quality score for each of the areas in which the professor has provided a rating, so as to better match the system to the quality of a particular rating by the professor.

At box 502, a user's ratings are identified and the categories in which those ratings were made are also identified. For example, items that were rated by a particular user may be associated with a limited set of topic descriptors such as by analyzing the text of the item and of items on surrounding pages, and also analyzing the text of comments submitted about the item. The process 500 may then classify each user rating according to such topics, and obtain information relating to rating levels provided by each user that has rated the relevant items. At box 504, the process 500 computes a quality score for one category or topic of items. The score may be a score indicating a correlation or lack of correlation between ratings given by the particular user and ratings given by other users. The process 500 may then return to a next category or topic if all categories or topics have not been analyzed (box 506).

With scores assigned for a user in each of multiple different categories, a composite quality score can also be generated. Such a score may be computed, such as by the process for computing gamma scores discussed above. Alternatively, the various quality scores for the various categories may be combined in some manner, such as by generating an average score across all categories or a weighted score. Thus, in ranking rated items, the particular modifiers to be used for a particular rating may be a modifier computed for a user with respect only to a particular category rather than an overall modifier. Specifically, in the example of the processor, rankings of wines that were reviewed favorably by the professor may be decreased, whereas physics articles rated high by the professor may be increased in ranking.

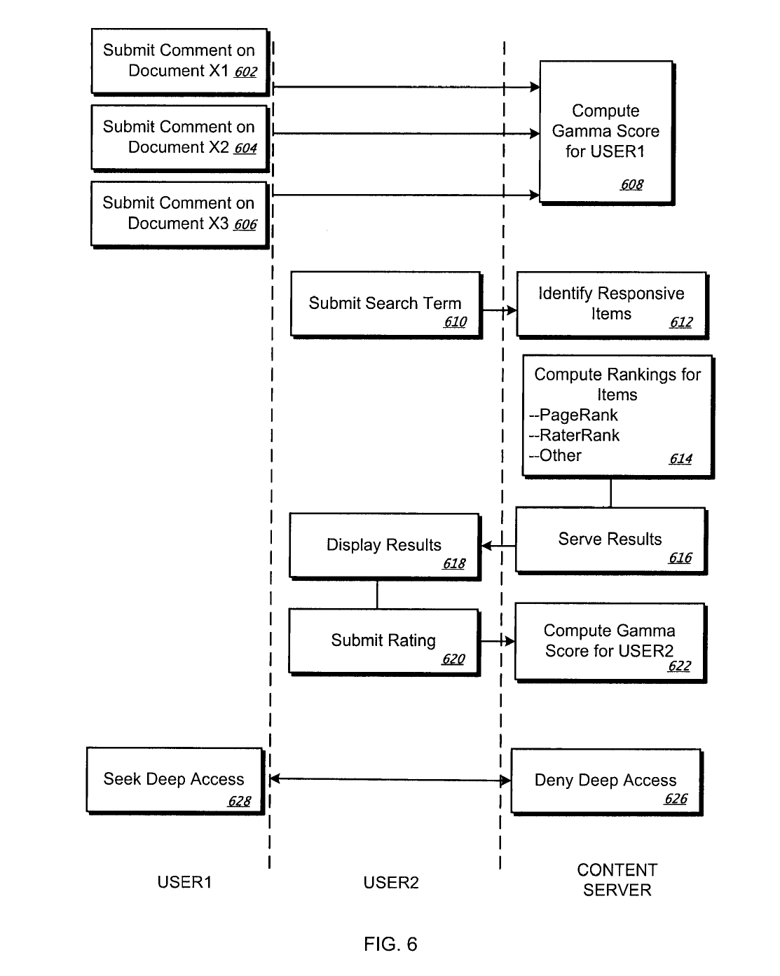

FIG. 6 is a swim lane diagram showing actions relating to rating of items on a network. In general, an example process 600 is shown to better exhibit actions that may be taken by various entities in a rating and ranking system. For this example, a first user labeled USER1 provides rankings, and a second user labeled USER2 later enters a search term and receives search results that are ranked according to a corrected version of rankings provided by users such as USER1. At boxes 602-606, USER1 provides comments and/or ratings on three different web-accessible documents. For example, the user may provide a quality ranking for a document, such as 1 to 5 stars, to serve as a recommendation to other users. A content server that hosts or is associated with the particular document then computes scores for each submitting user (box 608). In addition, revised or corrected ratings for each of the original documents may be generated.

At some later time, another user, USER2, may submit a standard search request to the system (box 610). The relevant results may include, among other things, one or more of the documents rated by the USER1. At box 612, the responsive documents are identified by standard techniques, and at box 614, the rankings of responsive documents are computed. The rankings may depend on a number of various input signals that may each provide an indicator of relevancy of a particular document for the search. For example, a responsive document's relevance may be computed as a function of the number of other documents that link to or point to the responsive document, and in turn upon how relevant those pointing documents are—in general, the well-known GOOGLE PAGERANK system. Other signals may also be used, such as data about how frequently people who have previously been presented with each search result have selected the result, and how long they have stayed at the site represented by the result.

In addition, the result rankings may also be affected by ratings they have received from various users. For example, an average modified rating may be applied as a signal so that documents having a higher average rating will be pushing upward relative to documents having a lower relative average rating. The ratings may be modified in that certain ratings may be removed or certain raters may have their ratings changed by a factor, where the raters have been found to differ from the norm in rating documents. Such modifications of raw ratings may occur, in certain examples, according to the techniques described above, and may be referenced as a RaterRank scoring factor. Such a rater ranking may be combined with other ranking signals in a variety of manners in which to generate a ranking score for each result, and thus a ranking order for the group of results.

With the search results ranked properly, they may be transmitted to the device of USER2 (box 616), and displayed on that device (box 618). USER2 may subsequently decide to select one of the search results, review the underlying document associated with the document, and rate the document. Such a rating may be associated with the document and with USER2. A gamma score like that discussed above may then be formulated for USER2 (a score might also be withheld until the user has rated a sufficient number of documents so as to make a determination of a score for the user statistically significant).

In one scenario, the rating by USER2 may differ significantly from the rating for the same document by USER1. Also, the ratings by USER1 for that and other documents may differ significantly from the ratings applied by other users for the same documents. In short, the ratings by USER1 may lack concurrence with the ratings form other users. As such, USER1 may have a low gamma number, and may be determined by the system to be a “bad” rater—perhaps because USER1 has evil motives or perhaps because USER1 simply disagrees with most people.

At box 624, USER1 seeks particular privileges with the system. For example, the system may provide web page hosting for certain users or may permit access to “professional” discussion for a for high-value users. However, at box 626, the system denies such special privileges because of the user's poor rating abilities. The system may alternatively provide other responses to the user based on their rating ability, such as by showing the user's rating score to other users (so that they can handicap other ratings or reviews that the user has provided), by making the user's ratings more important when used by the system, and other such uses.

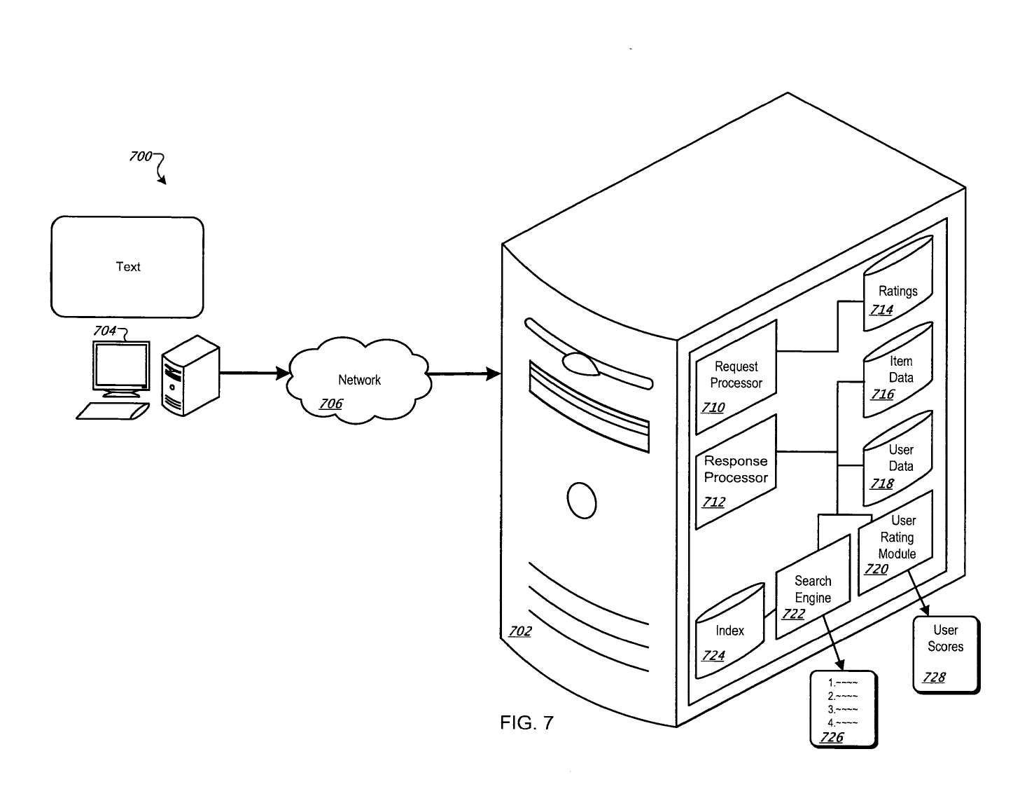

FIG. 7 is a schematic diagram of a system 700 for managing on-line ratings. In general, the system 700 includes components for tracking ratings provided by users to one or more various forms of items, such as products or web-accessible documents, and using or adjusting those ratings for further use. The system 700, in this example, may include a server system 702, which may include one or more computer servers, which may communicate with a plurality of client devices such as client 704 through a network 706, such as the internet.

The server system 702 may include a request processor 710, which may receive requests from client devices and may interpret and format the requests for further use by the system 702. The request processor 702 may include, as one example, one or more web servers or similar devices. For example, the request processor may determine whether a received request is a search request (such as if the submission is provided to a search page) and may format the request for a search engine, or may determine that a submission includes a rating of an item from a user.

Received ratings may be provided to a user rating module 720 and to search engine 722. The user rating module may tracking various ratings according to the users that have provided them, so as to be able to generate user scores 728, which may be indicators, like the gamma score discussed above, of the determined quality of a rater's ratings.

The user rating module 720 may draw on a number of data sources. For example, ratings database 714 may store ratings that have been provided by particular users to particular items. Such storage may include identification of fields for a user ID, an item ID, and a rating level. The item data database 716 may store information about particular items. For example, the item database may store descriptions of items, or may store the items themselves such as when the items are web pages or web comments.

User data database 718 may store a variety of information that is associated with particular users in a system. For example, the user data database 718 may at least include a user ID and a user credential such as a password. In addition, the database 718 may include a user score for each of a variety of users, and may also include certain personalization information for users.

The search engine 722 may take a variety of common forms, and may respond to search queries received via request processor 710 by applying such queries to an index of information 724, such as an index built using a spidering process of exploring network accessible documents. The search engine may, for example, produce a list of ranked search results 726. The search engine 724 may take into account, in ranking search results, data about ratings provided to various documents, such as obtained from ratings database 714. In certain implementations, the ratings accessed by search engine 722 may be handicapped ratings, in which the ratings are adjusted to take into account past rating activity by a user. For example, if a user regularly exceeds ratings by other users for the same item, the user's ratings may be reduced by an amount that would bring the ratings into like with most other users. Also, a weighting to be given to a user's ratings when combining ratings across multiple users may be applied to lessen the impact of a particular user's ratings.

The response formatter 712 may receive information, such as user scores 728 from user rating module 720 or search results 726 from search engine 722, and may format the information for transmission to a client device, such as client 704. For example, the response formatter may receive information that is responsive to a user request from a variety of sources, and may combine such information and format it into an XML transmission or HTML document, or the like.

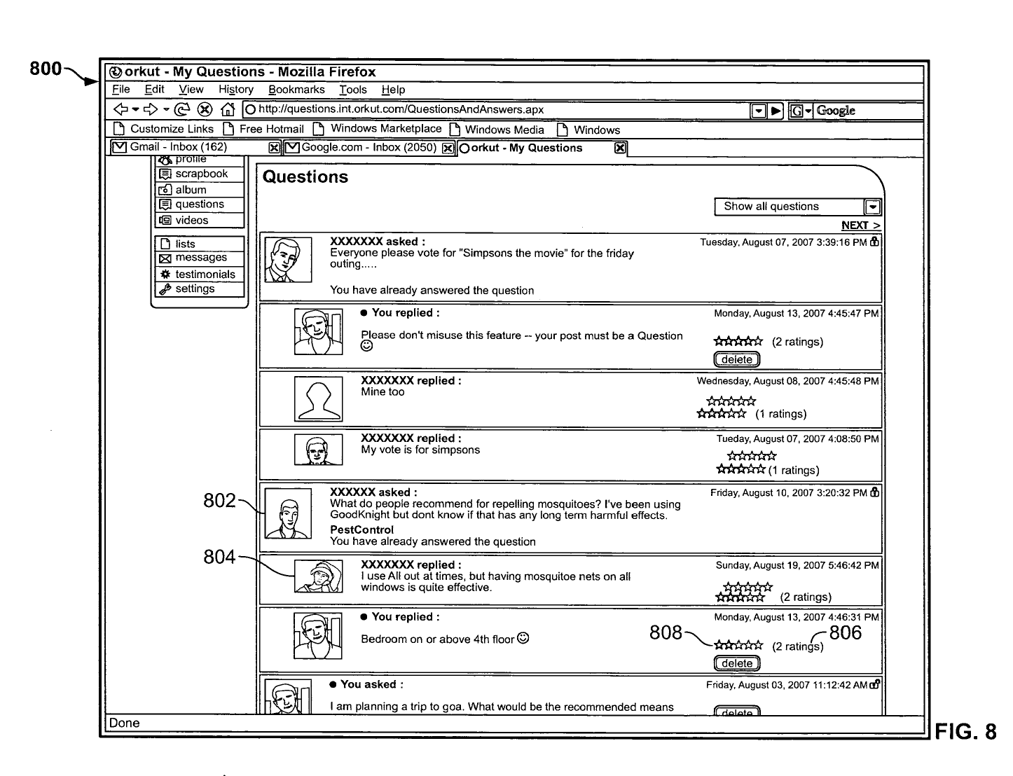

FIG. 8 is a screen shot 800 of an example application for tracking user ratings. In general, the screen shot 800 shows an example display for an application that allows users to ask questions of other user, or other users to provide answers, and for various users to give rankings to the answers or to other answers from other users.

Shown in the figure is a discussion string running from top to bottom, showing messages from one user to others. For example, a discussion thread may start with one user asking a question, and other users responding to the question, or responding to the responses from the other users. For example, in entry 802, user Sanjay asks other members of the community what they recommend for repelling mosquitoes Entry 804 includes a response or answer from Apurv, which other users may rate, indicating whether they believe the answer was helpful and accurate or not.

Each discussion string entry is provided with a mechanism by which other users may rate a particular entry. For example, average rating 808 shows an average of two ratings provided to the comment by various other users, such as users who have viewed the content. Rating index 606 also shows a user how many ratings have been provided. Thus, the ratings may be used as an input to a rating adjustment process and system, and the displayed ratings may become adjusted ratings rather than raw ratings, such as by the techniques discussed above.

The systems and techniques just discussed may be used in a variety of settings in addition to those discussed above. As one example, content submitted by various authors may be scored with such a system, where the content is displayed with its adjusted ratings, and its position in response to search requests may be elevated if it has a high rating. Also, users themselves may be assigned quality scores. Those scores may be shown to other users so that the other user may determine whether to read a comment provide by a user regarding a particular item. One example may involve the rating by users of consumer electronics; certain users may provide great ratings that are subsequently indicated as being helpful (or not helpful) by other users (much like the AMAZON review system currently permits, i.e., “was this review useful to you?”); such highly-qualified user may be provided a high score, as long as their high ratings came from other users who are determined to be legitimate. By such a process, certain users may be identified as super-raters, and such users may be singled out for special treatment. For example, such users may be provided access to additional private features of a system, among other things. In addition, such raters may be indicated with a particular icon, much like super sellers on the EBAY system.

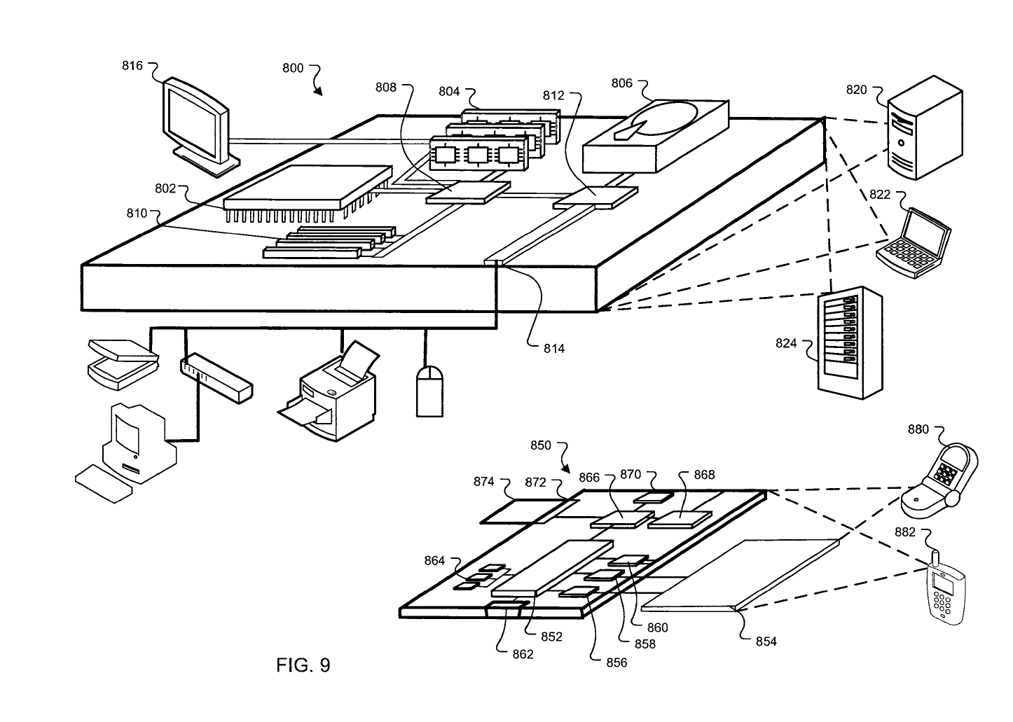

FIG. 9 shows an example of a generic computer device 900 and a generic mobile computer device 950, which may be used with the techniques described here. Computing device 900 is intended to represent various forms of digital computers, such as laptops, desktops, workstations, personal digital assistants, servers, blade servers, mainframes, and other appropriate computers. Computing device 950 is intended to represent various forms of mobile devices, such as personal digital assistants, cellular telephones, smartphones, and other similar computing devices. The components shown here, their connections and relationships, and their functions, are meant to be exemplary only, and are not meant to limit implementations of the inventions described and/or claimed in this document.

Computing device 900 includes a processor 902, memory 904, a storage device 906, a high-speed interface 908 connecting to memory 904 and high-speed expansion ports 910, and a low speed interface 912 connecting to low speed bus 914 and storage device 906. Each of the components 902, 904, 906, 908, 910, and 912, are interconnected using various busses, and may be mounted on a common motherboard or in other manners as appropriate. The processor 902 can process instructions for execution within the computing device 900, including instructions stored in the memory 904 or on the storage device 906 to display graphical information for a GUI on an external input/output device, such as display 916 coupled to high speed interface 908. In other implementations, multiple processors and/or multiple buses may be used, as appropriate, along with multiple memories and types of memory. Also, multiple computing devices 900 may be connected, with each device providing portions of the necessary operations (e.g., as a server bank, a group of blade servers, or a multi-processor system).

The memory 904 stores information within the computing device 900. In one implementation, the memory 904 is a volatile memory unit or units. In another implementation, the memory 904 is a non-volatile memory unit or units. The memory 904 may also be another form of computer-readable medium, such as a magnetic or optical disk.

The storage device 906 is capable of providing mass storage for the computing device 900. In one implementation, the storage device 906 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier is a computer- or machine-readable medium, such as the memory 904, the storage device 906, memory on processor 902, or a propagated signal.

The high speed controller 908 manages bandwidth-intensive operations for the computing device 900, while the low speed controller 912 manages lower bandwidth-intensive operations. Such allocation of functions is exemplary only. In one implementation, the high-speed controller 908 is coupled to memory 904, display 916 (e.g., through a graphics processor or accelerator), and to high-speed expansion ports 910, which may accept various expansion cards (not shown). In the implementation, low-speed controller 912 is coupled to storage device 906 and low-speed expansion port 914. The low-speed expansion port, which may include various communication ports (e.g., USB, Bluetooth, Ethernet, wireless Ethernet) may be coupled to one or more input/output devices, such as a keyboard, a pointing device, a scanner, or a networking device such as a switch or router, e.g., through a network adapter.

The computing device 900 may be implemented in a number of different forms, as shown in the figure. For example, it may be implemented as a standard server 920, or multiple times in a group of such servers. It may also be implemented as part of a rack server system 924. In addition, it may be implemented in a personal computer such as a laptop computer 922. Alternatively, components from computing device 900 may be combined with other components in a mobile device (not shown), such as device 950. Each of such devices may contain one or more of computing device 900, 950, and an entire system may be made up of multiple computing devices 900, 950 communicating with each other.

Computing device 950 includes a processor 952, memory 964, an input/output device such as a display 954, a communication interface 966, and a transceiver 968, among other components. The device 950 may also be provided with a storage device, such as a microdrive or other device, to provide additional storage. Each of the components 950, 952, 964, 954, 966, and 968, are interconnected using various buses, and several of the components may be mounted on a common motherboard or in other manners as appropriate.

The processor 952 can execute instructions within the computing device 950, including instructions stored in the memory 964. The processor may be implemented as a chipset of chips that include separate and multiple analog and digital processors. The processor may provide, for example, for coordination of the other components of the device 950, such as control of user interfaces, applications run by device 950, and wireless communication by device 950.

Processor 952 may communicate with a user through control interface 958 and display interface 956 coupled to a display 954. The display 954 may be, for example, a TFT (Thin-Film-Transistor Liquid Crystal Display) display or an OLED (Organic Light Emitting Diode) display, or other appropriate display technology. The display interface 956 may comprise appropriate circuitry for driving the display 954 to present graphical and other information to a user. The control interface 958 may receive commands from a user and convert them for submission to the processor 952. In addition, an external interface 962 may be provide in communication with processor 952, so as to enable near area communication of device 950 with other devices. External interface 962 may provide, for example, for wired communication in some implementations, or for wireless communication in other implementations, and multiple interfaces may also be used.

The memory 964 stores information within the computing device 950. The memory 964 can be implemented as one or more of a computer-readable medium or media, a volatile memory unit or units, or a non-volatile memory unit or units. Expansion memory 974 may also be provided and connected to device 950 through expansion interface 972, which may include, for example, a SIMM (Single In Line Memory Module) card interface. Such expansion memory 974 may provide extra storage space for device 950, or may also store applications or other information for device 950. Specifically, expansion memory 974 may include instructions to carry out or supplement the processes described above, and may include secure information also. Thus, for example, expansion memory 974 may be provide as a security module for device 950, and may be programmed with instructions that permit secure use of device 950. In addition, secure applications may be provided via the SIMM cards, along with additional information, such as placing identifying information on the SIMM card in a non-hackable manner.

The memory may include, for example, flash memory and/or NVRAM memory, as discussed below. In one implementation, a computer program product is tangibly embodied in an information carrier. The computer program product contains instructions that, when executed, perform one or more methods, such as those described above. The information carrier is a computer- or machine-readable medium, such as the memory 964, expansion memory 974, memory on processor 952, or a propagated signal that may be received, for example, over transceiver 968 or external interface 962.

Device 950 may communicate wirelessly through communication interface 966, which may include digital signal processing circuitry where necessary. Communication interface 966 may provide for communications under various modes or protocols, such as GSM voice calls, SMS, EMS, or MMS messaging, CDMA, TDMA, PDC, WCDMA, CDMA2000, or GPRS, among others. Such communication may occur, for example, through radio-frequency transceiver 968. In addition, short-range communication may occur, such as using a Bluetooth, WiFi, or other such transceiver (not shown). In addition, GPS (Global Positioning System) receiver module 970 may provide additional navigation- and location-related wireless data to device 950, which may be used as appropriate by applications running on device 950.

Device 950 may also communicate audibly using audio codec 960, which may receive spoken information from a user and convert it to usable digital information. Audio codec 960 may likewise generate audible sound for a user, such as through a speaker, e.g., in a handset of device 950. Such sound may include sound from voice telephone calls, may include recorded sound (e.g., voice messages, music files, etc.) and may also include sound generated by applications operating on device 950.

The computing device 950 may be implemented in a number of different forms, as shown in the figure. For example, it may be implemented as a cellular telephone 980. It may also be implemented as part of a smartphone 982, personal digital assistant, or other similar mobile device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

A number of embodiments have been described. Nevertheless, it will be understood that various modifications may be made. For example, various forms of the flows shown above may be used, with steps re-ordered, added, or removed. Also, although several applications of the rating modification systems and methods have been described, it should be recognized that numerous other applications are contemplated. Moreover, although many of the embodiments have been described in relation to particular mathematical approaches to identifying rating-related issues, various other specific approaches are contemplated. Accordingly, other embodiments are within the scope of the following claims.

What is claimed is:

1. A computer-implemented method, comprising:
performing in one or more computers operations comprising:
identifying a plurality of ratings on a plurality of items, wherein the plurality of ratings are made by a first user;
determining one or more differences between the plurality of ratings, and ratings by other users associated with the items; and
generating a quality score for the first user using the one or more differences.

2. The method of claim 1, wherein the plurality of ratings are explicit ratings within a bounded range.

3. The method of claim 1, further comprising identifying the first user by receiving from the first user an ID and password.

4. The method of claim 1, wherein the items comprise web-accessible documents.

5. The method of claim 4, further comprising ranking one or more of the web-accessible documents using the quality score.

6. The method of claim 5, further comprising receiving a search request and ranking search results responsive to the search request using quality scores for a plurality of users rating one or more of the search results.

7. The method of claim 4, further comprising generating scores for authors of one or more of the web-accessible documents using the quality score.

8. The method of claim 1, wherein the item comprises a user comment.

9. The method of claim 1, wherein the quality score is based on an average difference between the first user's rating and other ratings for each of a plurality of items.

10. The method of claim 9, wherein the quality score is compressed by a logarithmic function.

11. The method of claim 1, further comprising generating modified ratings for the plurality of items using the quality score.

12. The method of claim 1, further comprising generating a quality score for a second user based on the quality score of the first user and comments relating to the second user by the first user.

13. A computer-implemented system, comprising:
memory storing ratings by a plurality of network-connected users of a plurality of items;
a processor operating a user rating module to generate ratings for users based on concurrence between ratings of items in the plurality of items by a user and ratings by other users; and
a search engine programmed to rank search results using the generated ratings for users.

14. The computer-implemented system of claim 13, wherein the plurality of ratings are contained within a common bounded range.

15. The computer-implemented system of claim 13, wherein the user rating module is programmed to generate a rating for a first user by comparing a rating or ratings of an item by the first user to an average rating by users other than the first user.

16. The computer-implemented system of claim 13, wherein the search results comprise a list of user-rated documents.

17. The computer-implemented system of claim 13, wherein the ratings of items are explicit ratings.

18. The computer-implemented system of claim 13, wherein the rating module further generates rating information for authors of the items using the generated ratings for users.

19. A computer-implemented system, comprising:
memory storing ratings by a plurality of network-connected users of a plurality of items;
means for generating rater quality scores for registered users who have rated one or more of the plurality of items; and
a search engine programmed to rank search results using the rater quality scores.

20. The system of claim 19, wherein the items comprise web-accessible documents having discrete, bound rankings from the network-connected users.
